(19) United States
(12) Patent Application Publication
(10) Pub. No.: US 2003/0017959 A1
(43) Pub. Date: Jan. 23, 2003

(54) Detergent particle

(75) Inventors: Andre Cesar Baeck, Bonheiden (BE); Hossam Hassan Tantawy, Morpeth (GB); Ann Katrien Marie Agnes Verschuere, Drongen (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/116,294

(22) Filed: Apr. 4, 2002

(30) Foreign Application Priority Data
Apr. 4, 2001 (GB) GB0108468.0

(51) Int. Cl. C11D 17/00

(52) U.S. Cl. 510/445; 510/446

(57) ABSTRACT

The present invention relates to a water-soluble and/or water-dispersible particle comprising an active ingredient uniformly dispersed, preferably an enzyme, in a matrix comprising from 20-95% by weight of the particle of polyvinyl alcohol of a molecular weight of 10-30K daltons. The present invention further relates to a process to obtain a particle, to a detergent composition comprising the particle and to the use of particle to minimize, reduce or prevent the generation of dust while providing excellent cleaning on enzyme sensitive stains and soils and on particulate stains, improved thermostability and fabric softness performance.

### CROSS REFERENCE TO RELATED APPLICATIONS

This application claims the benefit of Great Britain Patent Application No. GB0108468.0 filed on Apr. 4, 2001.

### TECHNICAL FIELD

The present invention relates to water-soluble and/or water dispersible particles, to water-soluble and/or water dispersible detergent particles, especially to water-soluble and/or water dispersible enzyme particle. The invention also relates to detergent compositions containing the water-soluble and/or water dispersible detergent particles, and methods for making the particles.

### BACKGROUND TO THE INVENTION

Cleaning compositions often comprise active ingredients which are to be delivered to water or which are required to be active in aqueous conditions, but which are sensitive to moisture, temperature changes, light and/or air during storage. Also, these compositions often contain ingredients which may react with one another. For example enzymes, used in detergents, are often incompatible with alkaline or acid materials, bleaches, moisture and light, and, thus, are coated to protect them.

Attempts have been made to produce enzyme particles which are more stable, for example freeze-drying processes have been used to produce enzyme particles, such as described in EP320483. However, freeze-drying is a very expensive, time consuming and inefficient way to obtain enzyme particles. The freeze drying step is not always compatible with all enzymes, especially freeze-thaw intolerant enzymes. This limits the usefulness of such a process for preparing enzyme particles and particles comprising other active ingredients.

Other attempts have been to produce enzyme particles which are more stable, which are made by a non-freeze drying process. For example, enzyme cores have been coated with one or more layers of coating material(s) to obtain enzyme particles, such as described in EP862623. Therefore, such ingredients or actives are often protected or separated from one another by coating agents. Because the active materials generally need to be delivered in aqueous conditions, the coating materials need to be chosen such that the coating and actives dissolve or disperse well in water.

However, these processes produce particles which generate dust during handling and processing in a manufacturing plant, due to physical forces exerted on them. This not only creates waste product, but the dust can also cause hygiene and health problems. The problem with these particles is that they are not robust enough to withstand the forces which occur during handling and processing of the particles, which results in the generation of dust. One solution to reduce dust formation that is proposed in the prior art, is to make these particles harder. WO98/26037 aims at developing a coating system for dust-free enzyme granulates, comprising 50-70%wt of a finely divided inorganic, water-soluble pigment; 45-90%wt of a water-soluble organic substance solid at room temperature and with a melting point from 45-65° C., and up to 20% of a flowability improving agent. Genencor publications WO93/07263 and WO9723606 propose several granular enzyme compositions having reduced tendencies to form dust and leave residues, exhibiting improved stability and delayed release characteristics. Such granular composition comprises a core, an enzyme layer and an outer coating layer. The enzyme layer and optimally the core and coating layers contain a vinyl polymer.

U.S. Pat. No. 4,176,079 describes a non-dusting article, primarily for use in detergent composition comprising an enzyme dispersed in a water-soluble resin film, wherein one dimension of the article is at least 3 millimetres in size and the thickness of the article is no more than about 1000 millimetres. A preferred method for making these articles is by dispersing enzyme into a water-soluble resin, casting or extruding the resin into a sheet and then drying or cooling it, if necessary. WO01/25390 discloses a foam component comprising polymeric material and an active ingredient, being stable upon contact with air but dissolves in water and WO01/24779 describes a coating agent for solid or non-aqueous composition which is made from such foam component. WO01/25323 relates to an elastic article comprising polymeric material and an active ingredient, characterized by a glass transition temperature below 50° C.

In addition, it is necessary that such non-dusting article demonstrates no negative impact on the cleaning and fabric care performance when it is implemented into detergent and/or fabric care compositions. Indeed, it has been surprisingly found that some of the non-dusting granules described in the art demonstrate particulate stain removal negatives and/or fabric softening negatives.

The Inventors have now overcome the above problems by providing a particle which is capable of delivering an active ingredient, preferably an enzyme, to an aqueous environment, which exhibits low- or nil-dust generation during handling and processing in a manufacturing plant. The particles are produced in a cost-efficient manner, and do not pose the health and hygiene risks associated with the processing of current enzyme particles. It has been surprisingly found that a particle, wherein the active, preferably an enzyme, is uniformly dispersed in a matrix comprising from 20-95% by weight of the particle of polyvinyl alcohol of a molecular weight (Mn) of 10-30K daltons, demonstrates excellent anti-dusting properties as well as excellent cleaning performance on enzyme sensitive stains and soils and on particulate stains. Furthermore such detergent particles are compatible with the fabric softness performance of clay comprising detergents. In addition, it has been found that the detergent particles, in particular the enzyme particle of the present invention demonstrates increased thermal stability versus conventional detergent granules, in particular enzyme granules.

The active ingredient(s) incorporated in the particle are also effectively protected, not only against air-moisture and chemical reactions, but also against physical forces.

### SUMMARY OF THE INVENTION

The present invention relates to a water-soluble and/or water-dispersible particle with a particle size ranging from 200 μm to 2000 μm. The particle comprises an active ingredient uniformly dispersed, preferably an enzyme, in a matrix comprising from 20%-95% by weight of the particle of polyvinyl alcohol of a molecular weight (Mn) of 10-30K daltons.

In another embodiment, the present invention relates to an extruded water-soluble and/or water-dispersible particle with a particle size of less than 20 mm comprising an active ingredient uniformly dispersed in a matrix which comprises from 20%-95% by weight of the particle of polyvinyl alcohol of a molecular weight (Mn) of from 10K to 30K daltons.

The particles are suitable for delivering the active ingredient to an aqueous environment.

The present invention further relates to a process to obtain a particle. The process comprises mixing the matrix, an active ingredient, preferably an enzyme and optionally other adjunct ingredients to form a mixture. The mixture is formed into particles.

The present invention also relates to a detergent composition comprising the particle and to the use of the particle to minimize, reduce or prevent the generation of dust while maintaining excellent cleaning on enzyme sensitive stains and soils and on particulate stains, as well as to deliver improved thermostability utilizing particles which are compatible with clay fabric softening technology.

All documents cited are, in relevant part, incorporated herein by reference; the citation of any document is not to be construed as an admission that it is prior art with respect to the present invention.

### DETAILED DESCRIPTION

As “used herein, the expressions “uniformly dispersed” or “in a uniformly dispersed state” refer to a state wherein the active ingredient and the polymer are not segregated in separate layers. The enzyme and the polymer are not necessarily in a dispersed state on the molecular level and they may be present as a dispersed powder.

The non-dusting particle of the present invention demonstrates no negative impact on the cleaning and fabric care performance when it is implemented into detergent and/or fabric care compositions. Indeed, it has been surprisingly found that some of the non-dusting granules described in the art demonstrate particulate stain removal negatives and/or fabric softness negatives. Without wishing to be bound by theory, it is believed that this is due to the interaction polymer—particle. Certain polymers do have an effect on the dispersing or on the precipitation of particulates, e.g. clay particles. It has been found that even low levels of high molecular weight polymers impact on clay dispersions, i.e. tend to flocculate particulate dispersions or to fix particulates onto fabrics; causing undesirable stain removal negatives. It has also been surprisingly found that low molecular polymers tend to disperse stacks of clay platelets, and thereby reduce the fabric softening performance of clay comprising detergent/fabric care compositions, by reducing the deposition of the clay softening materials onto the fabric.

It has been surprisingly found that a detergent particle, wherein the active, preferably the enzyme, is uniformly dispersed in a matrix comprising from 20-95% by weight of the particle of polyvinyl alcohol of a molecular weight (Mn) of 10-30K daltons, demonstrates excellent anti-dusting properties as well as excellent cleaning performance on enzyme sensitive stains and soils and on particulate stains. Furthermore such detergent particles are compatible with the softness performance of clay comprising detergents. In addition, it has been found that the detergent particles, in particular the enzyme particle of the present invention, and in particular enzyme granules, demonstrate increased thermal stability versus conventional detergent granules.

MATRIX—The Polymer

The matrix comprises 20-95%, preferably from 25% to 80%, more preferably from 35% to 75% by weight of the particle of a polyvinyl alcohol polymer (PVA). As used herein the term “PVA” means a polyvinyl alcohol polymer and/or derivatives thereof including co-polymers thereof, ter-polymers thereof, and combinations thereof.

The PVA to be used in the matrix of the present invention has a number average molecular weight (Mn) of from 10K (10.000) to 30K (30.000) daltons, preferably from 10K (10.000) to 20K (20.000) daltons. Mn (Number average molecular weight) is the total weight of all molecules divided by the number of molecules, as described in the DRISCOPIPE, Technical Note #25, PD TN-25, May 1996 on page 2.

Chemically, PVA can be described as a polyhydric alcohol with hydroxyl groups extending from alternate carbon atoms. It is represented structurally as having the following repeating units: (CH2—CH)n

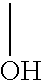

PVA is prepared via hydrolysis of polyvinylacetate. Depending on the degree of hydrolysis, PVA can be obtained in grades which are soluble in both cold and hot water or hot water only. A highly preferred polymeric material is a PVA supplied by Clariant GmbH under the trade name MOWIOL. Especially preferred grades of this PVA are the 3-83 grades.

Preferably, the matrix itself is water-soluble and/or water-dispersible, and has similar or the same water-solubility and/or water-dispersibility properties as described hereinbelow for the particle.

Preferably, such polymers have a level of hydrolysis of at least 50%, more preferably at least 65% or even from 70% to 90%. The solubility of PVA can indeed be altered by varying the level of hydrolysis of the PVA. It has been further found that such hydrolysis degree is preferred for compatibility with the deposition of clay-like material in 2-in-1 detergent compositions wherein such type of clay materials are deposited during the wash to provide fabric softness.

The matrix preferably has a glass transition temperature (Tg) of 60° C. or less, preferably 50° C. or less, or 40° C. or less, or 35° C. or less, and preferably to −100° C., or to −50° C., or to −35° C., or to −20° C., or to −10° C. Particles comprising a matrix having a Tg within the ranges specified herein, generate less- or nil- dust during handling and processing in a manufacturing plant. Preferably, the Tg properties of the matrix are achieved by using PVA and a suitable amount of plasticizer. Preferably, PVA can be plasticized to have similar Tg properties as described hereinabove for the matrix. Please refer to WO 01/24323 published in the name of The Procter and Gamble Company on Apr. 12, 2001, wherein the glass transition temperature is defined on page 5.

The matrix can comprise further polymeric material. Mixtures of polymers may in particular be beneficial to control the mechanical and/or dissolution properties of the particle, depending on the application and the requirements thereof.

Such further polymeric material may comprise cellulosic material or derivatives thereof including carboxymethyl cellulose, methyl cellulose, hydroxy ethyl cellulose, hydroxy propyl methyl cellulose, hydroxy propyl cellulose, and combinations thereof. Such further polymeric material may also comprise: polyvinyl pyrrolidone (PVP) and/or derivatives thereof; cellulose ethers and/or derivatives thereof; polyacrylamide and/or derivatives thereof; polyethylene oxide and/or derivatives thereof; polyethylene imine and/or derivatives thereof; and any combination thereof. The polymeric material may comprise co-polymers of the polymers described hereinabove with one another, or with other monomers or oligomers.

It may also comprise a starch. Preferred starches include, raw starch, pre-gelatinized starch and modified starch derived from tubers, legumes, cereal and grains. Preferred starches are dextrine, corn starch, wheat starch, rice starch, waxy corn starch, oat starch, cassava starch, waxy barley, waxy rice starch, glutenous rice starch, sweet rice starch, amioca starch, potato starch, tapioca starch, oat starch, cassava starch, derivatives thereof, and combinations thereof. Highly preferred starches are pre-gelatinized starches. Most preferred starches are corn starch, waxy corn starch, potato starch, derivatives thereof, and combinations thereof.

Preferred modified starches are starch hydrolyzates (hydrolysis product of starches), hydroxyalkylated starch, starch esters, cross-linked starch, starch acetates, octenyl succinated starch, oxidized starch, derivatives thereof and any combination thereof. Properties such as absorption, encapsulation, retention and release of the active ingredient can be modified by using starches with different degrees of modification. The viscoelastic properties of the particle can be modified by controlling the percent amylose/amylopectin present in the starch and the degree of gelatinization in the starch. It may be preferred that the polymeric material comprises a combination of a modified starch and a pre-gelatinized starch. If the matrix further comprises a starch, then preferred plasticizers are glycerol, sorbitol, mannitol, sucrose, maltose, glucose, urea, derivatives thereof, and any combination thereof.

Preferred polymeric material comprises PVA in combination with starch and/or chemically modified starch. Preferably the weight ratio of PVA to starch is from 1:1 or above, or from 5:1 or above.

MATRIX—The Plasticizer

The matrix preferably comprises a plasticizer. Any plasticizer which is suitable to aid the formation of a matrix as defined herein can be used. Mixtures of plasticizer may also be used. Preferably, when water is used, an additional plasticizer is present. The polymeric material may be internally plasticized: internally plasticized PVOHs such as those described in Polyvinyl Alcohol Properties & Applications, 2^{nd} edition, edited by C A Finch, published by John Wiley & Sons.

Preferably, the plasticizer or at least one of the plasticizers, has a boiling point above 40° C., preferably above 60° C., or even above 95° C., or even above 120° C., or even above 150° C.

Suitable plasticizers for PVA are: water-soluble organic compounds comprising hydroxy, amide and/or amino groups. glycerol; glycol derivatives including ethylene glycol and/or propylene glycol; polyglycols; digomeric polyethylene glycols such as diethylene glycol, triethylene glycol and tetraethylene glycol; polyethylene glycol with a number average molecular weight of from about 200 to about 1500 grams/mole; wax and derivatives thereof including carbowax; ethanolacetamide; ethanolformamide; triethanolamine and/or derivatives thereof including acetate derivatives thereof and ethanolamine salt derivatives thereof; sodium thiocyanates; ammonium thiocyanates; polyols including 1,3-butanediol; sugars, including hydroxy propyl sucrose; sugar alcohols; sorbitol; sulphonated oils; ureas; dibutyl and/or dimethyl pthalate; oxa monoacids; oxa diacids; diglycolic acids and derivatives thereof including other linear carboxylic acids with at least one ether group distributed along the chain; water; or any combination thereof. Other preferred plasticizers are nonionic surfactants.

Preferred plasticizers to be used with the PVA of the present invention are glycerol, polyethylene glycols with a number average molecular weight of from about 200 to about 1500 grams/mole, water, ethylene glycol, trimethylene glycol, tetramethylene glycol, pentamethylene glycol, hexamethylene glycol, propylene glycol, 2,3-butane diol, 1,2-butane diol, diethylene glycol, triethylene glycol, tetraethylene glycol, nonaethylene glycol derivatives thereof, ethanol acetamide, ethanol formamide, ethanol amine salts, urea-formaldehyde, phenol-formaldehyde, and any combination thereof. More preferred are water, glycerol and/or polyethylene glycols with a number average molecular weight of from about 200 to about 1500 grams/mole.

The plasticizer is preferably present at a level of at least 0.5% by weight of the particle or more preferably by weight of the matrix, provided that when water is the only plasticizer it is present at a level of above 2%, preferably at least 3% by weight of the particle, or more preferably by weight of the matrix. Preferably, the plasticizer is present at a level of from 1% to 60% by weight of the particle or matrix, more preferably from 2%, or from 3%, or from 4%, or from 5%, or from 6%, or from 7%, or from 8% by weight of the particle or matrix, and preferably to 50%, or to 40%, or to 25%, or to 15% or to 12% by weight of the particle or matrix. The exact level will depend on the plasticizer used, and is preferably such that the matrix has the desired properties which result in the particle being resistant to dust generation. This is described in more detail hereinafter. For example, when glycerol or ethylene glycol or other glycol derivatives are used, higher levels may be preferred, for example 2% to 30% by weight of the particle or matrix.

The weight ratio of PVA to plasticizer in the matrix is preferably from 1:1 to 100:1, more preferably from 1:1 to 70:1, or from 1:1 to 50:1, more preferably from 1:1 to 30:1, or even from 1:1 to 20:1, again depending on the type of plasticizer and whether further polymeric material are used. For example, for PVA polymer of the present invention, when the plasticizer comprises glycerol and/or derivatives and optionally water, the ratio is preferably around 15:1 to 10:1, a preferred ratio being around 7:1.

The matrix is preferably viscoelastic, having similar or the same viscoelasticity and storage modulus, relative density, and/or flexible properties as described hereinbelow for the particle.

The properties of the matrix, in particular of the PVA materials and/or plasticizers comprised therein, can be modified to alter the storage modulus of the matrix and/or particle: a rigid matrix comprising a rigid polymeric material with a high storage modulus (E^{components}), can be made into a flexible matrix by adjusting the levels and/or type of plasticizer, and optionally by modifying the relative density of the particle (for example by introducing gas into the matrix to produce a porous or cellular structure.)

### ACTIVE INGREDIENT

The active ingredient can be any material which is to be delivered to a liquid environment, or preferably an aqueous environment and preferably an ingredient which is active in an aqueous environment. For example, when used in cleaning compositions the active ingredient can be any active cleaning ingredient.

In particular, it is beneficial to incorporate in the particle, active ingredients which are moisture sensitive or react upon contact with moisture, or ingredients which have a limited impact robustness and tend to form dust during handling. The active ingredient is typically a moisture sensitive ingredient, a temperature sensitive ingredient, an oxidizable ingredient, a volatile ingredient, or a combination thereof. The active ingredient preferably comprises enzymes, perfumes, bleaches, bleach activators, bleach catalysts, dye transfer inhibitors, fabric softeners, fabric conditioners, surfactants such as liquid nonionic surfactant, conditioners, antibacterial agents, effervescence sources, brighteners, photo-bleaches and any combination thereof. A highly preferred active ingredient comprises one or more enzymes, preferably a detergent enzyme, i.e. an enzyme suitable for a detergent composition; as described in details herein below.

The active ingredient is generally incorporated in the particle of the present invention at a level of from 0.1% to 55%, preferably from 0.5% to 35% active ingredient by weight of the particle. If the active ingredient is an enzyme, this level is expressed in % pure enzyme by weight of the particle.

Suitable enzymes include enzymes selected from peroxidases, proteases, glucoamylases, amylases, xylanases, cellulases, lipases, phospholipases, esterases, cutinases, pectin degrading enzymes, keratanases, keratinase, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof.

Protease

Suitable proteases are the subtilisins which are obtained from particular strains of B. subtilis, B. licheniformis and B. amyloliquefaciens (subtilisin BPN and BPN′), B. alcalophilus and B. lentus. Suitable Bacillus protease is ESPERASE® with maximum activity at pH 8-12, sold by Novozymes and described with its analogues in GB 1,243,784. Other suitable proteases include Alcalase®, Everlase, Durazym® and Savinase® from Novozymes and Properase® and Purafect Ox® from Genencor. Proteolytic enzymes also encompass modified bacterial serine proteases, such as those described in EP 251 446 (particularly pages 17, 24 and 98) referred to as “Protease B”, and in EP 199 404 which refers to a modified enzyme called “Protease A” herein. Also suitable is the “Protease C”, which is a variant of an alkaline serine protease from Bacillus in which lysine replaced arginine at position 27, tyrosine replaced valine at position 104, serine replaced asparagine at position 123, and alanine replaced threonine at position 274; and is described in WO 91/06637. Genetically modified variants, particularly of Protease C, are also included herein.

A preferred protease referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in WO95/10591 and in WO95/10592. Also suitable is a carbonyl hydrolase variant of the protease described in WO95/10591, having an amino acid sequence derived by replacement of a plurality of amino acid residues replaced in the precursor enzyme corresponding to position +210 in combination with one or more of the following residues: +33, +62, +67, +76, +100, +101, +103, +104, +107, +128, +129, +130, +132, +135, +156, +158, +164, +166, +167, +170, +209, +215, +217, +218, and +222, where the numbered position corresponds to naturally-occurring subtilisin from Bacillus amyloliquefaciens or to equivalent amino acid residues in other carbonyl hydrolases or subtilisins, such as Bacillus lentus subtilisin (WO98/55634).

Also preferred proteases are multiply-substituted protease variants. These protease variants comprise a substitution of an amino acid residue with another naturally occurring amino acid residue at an amino acid residue position corresponding to position 103 of Bacillus amyloliquefaciens subtilisin in combination with a substitution of an amino acid residue positions corresponding to positions 1, 3, 4, 8, 9, 10, 12, 13, 16, 17, 18, 19, 20, 21, 22, 24, 27, 33, 37, 38, 42, 43, 48, 55, 57, 58, 61, 62, 68, 72, 75, 76, 77, 78, 79, 86, 87, 89, 97, 98, 99, 101, 102, 104, 106, 107, 109, 111, 114, 116, 117, 119, 121, 123, 126, 128, 130, 131, 133, 134, 137, 140, 141, 142, 146, 147, 158, 159, 160, 166, 167, 170, 173, 174, 177, 181, 182, 183, 184, 185, 188, 192, 194, 198, 203, 204, 205, 206, 209, 210, 211, 212, 213, 214, 215, 216, 217, 218, 222, 224,227, 228, 230, 232, 236, 237, 238, 240, 242, 243, 244, 245, 246, 247, 248, 249, 251, 252, 253, 254, 255, 256, 257, 258, 259, 260, 261, 262, 263, 265, 268, 269, 270, 271, 272, 274 and 275 of Bacillus amyloliquefaciens subtilisin; wherein when said protease variant includes a substitution of amino acid residues at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin and/or multiply-substituted protease variants comprising a substitution of an amino acid residue with another naturally occurring amino acid residue at one or more amino acid residue positions corresponding to positions 62, 212, 230, 232, 252 and 257 of Bacillus amyloliquefaciens subtilisin as described in WO99/20723, WO99/20726, WO99/20727, WO99/20769, WO99/20770 and WO99/20771 (The Procter & Gamble and/or Genencor). Preferred multiply substituted protease variants have the amino acid substitution set 101/103/104/159/232/236/245/248/252, and more preferably 101 G/103A/104I/159D/232V/236H/245R/248D/252K according to the BPN′ numbering.

Also suitable for the present invention are proteases described in patent applications EP 251 446 and WO 91/06637, protease BLAP® described in WO91/02792 and their variants described in e.g. WO 95/23221, DE 19857543.

Current protein engineering technologies allow selecting and developing optimized proteolytic enzymes with better compatibility with the product matrix, application conditions and/or which demonstrate high specificity towards performance relevant parameters. In this context, the following enzymes have been developed and are suitable for the compositions of the present invention: Alkaline proteases such as described e.g. in WO 00/61769 (Cheil Co), JP 200060547 (Toto), JP11228992 (KAO), Bacillus sp. NCIMB 40338 described in WO 93/18140 (Novozymes); Acidic proteases such as those described in WO99/50380 (Novozymes); Psychrophylic protease as for example in WO 99/25848 (Procter & Gamble); Thermostable proteases, such as described in. WO 9856926 (Takara]); Proteases showing keratin hydrolyzing activity or blood or grass stain removal have also been developed such as those in. EP 1 036 840 (KAO), U.S. Pat. No. 6,099,588 (Novozymes), WO00/05352 (Procter & Gamble), WO 99/37323 (Genencor), U.S. Pat. No. 5,877,000 (Burtt); Proteases having reduced allergenicity, e.g. WO99/53078 (Genencor), WO99/48918 and WO99/49056 (Procter & Gamble); Several proteases having increased specific activity or showing improved robustness versus other detergent ingredients like surfactant, bleach, chelants, etc. have been developed and are described in the patent literature; and Proteases showing fabric care benefits.

Further suitable are metalloproteases such as those described in e.g. WO99/33959, WO99/33960, WO99/34001, WO99/34002, WO99/34003 all by Genencor and proteases described in e.g. the published application from WO00/03721 to WO00/03727. See also a high pH protease from Bacillus sp. NCIMB 40338 described in WO 93/18140 (Novozyme).

Enzymatic detergents comprising protease, one or more other enzymes, and a reversible protease inhibitor are described in WO92/03529 A to Novo. When desired, a protease having decreased adsorption and increased hydrolysis is available as described in WO95/07791 to Procter & Gamble. A recombinant trypsin-like protease for detergents suitable herein is described in WO 94/25583 to Novo. Unilever describes other suitable proteases in EP 516 200.

Amylase

Amylases (α and/or β) can be included for removal of carbohydrate-based stains. WO94/02597 (Novozymes) describes cleaning compositions that incorporate mutant amylases. See also WO95/10603 (Novozymes) Other amylases known for use in cleaning compositions include both α- and β-amylases. α-Amylases are known in the art and include those disclosed in U.S. Pat. No. 5,003,257; EP 252 666; WO91/00353; FR 2,676,456; EP 285 123; EP 525 610; EP 368 341; and GB 1,296,839. Other suitable amylases are stability-enhanced amylases described in WO94/18314 and WO96/05295, Genencor and amylase variants having additional modification in the immediate parent available from Novozymes disclosed in WO 95/10603. Also suitable are amylases described in EP 277 216, WO95/26397 and WO96/23873 (all by Novozymes Nordisk).

Examples of commercial α-amylases products are Purastar®, Purafect Ox Am® from Genencor and Natalase®, Termamyl®, Ban®, Fungamyl® and Duramyl®, all available from Novozymes. WO95/26397 describes other suitable amylases: α-amylases characterized by having a specific activity at least 25% higher than the specific activity of Termamyl® at a temperature range of 25° C. to 55° C. and at a pH value in the range of 8 to 10, measured by the Phadebas® α-amylase activity assay. Suitable are variants of the above enzymes, described in WO96/23873 Novozymes. Preferred variants therein are those with increased thermostability described on p16 of WO96/23873, and especially the D183*+G184* variant.

Current protein engineering technologies allow selecting and developing optimized amylases with better compatibility with the product matrix, application conditions and/or which demonstrate high specificity towards performance relevant parameters. In this context, the following enzymes have been developed and are suitable for the compositions of the present invention: Alkaline amylases such as described e.g. in EP 1 022 334, JP2000023665, JP2000023666, and JP2000023667 (all by KAO), JP 2000060546 (Toto), WO00/60058 (Novozymes); Acidic amylases such as in FR 2778412 (University Reims); Psychrophylic amylases; Amylases with improved thermostability, such as in e.g. WO99/02702 (Genencor); Amylases having reduced allergenicity; Amylases having increased specific activity or showing improved robustness versus other detergent ingredients like surfactant, bleach, chelants, etc. are useful and can be found in the patent literature, e.g.; as described in WO95/35382; and Amylases delivering fabric care benefits.

Also suitable are the following starch degrading enzymes:

Suitable Cyclomaltodextrin glucanotransferase “CGTase” (E.C. 2.4.1.19) are the CGTase described in WO96/33267, WO99/15633 and WO99/43793. More preferred are the CGTase variants of WO99/15633 showing an increased product specificity with respect to the production of β-cyclodextrin. Commercially available CGT-ases are the products sold under the tradenames Toruzyme by NovoZyme.

Suitable maltogenic alpha amylase (EC 3.2.1.133) are described in EP 120 693, WO99/43794 and WO99/43793. Preferred are the Novamyl enzyme described in EP 120 693; the Novamyl variant Δ (191-195)-F188L-T189Y (See example 4 of WO99/43793); and the variants of Novamyl Δ191-195 and F188L/T189Y/T142A/N327S (See example 5 of WO99/43794). Novamyl is commercially available from NovoZyme.

Beta-amylase EC 3.2.1.2, are also suitable. These 1,4-α-D-glucan maltohydrolases provide exohydrolysis of 1,4-α-D-glucosidic linkages in polysaccharides to remove successive maltose units from non-reducing ends of the chain.

Suitable amyloglucosidases EC 3.2.1.3. are described in WO92/00381, WO98/06805, WO99/28448 and WO00/04136 (All by NovoZyme). Commercially available amyloglucosidases are the enzyme products sold under the trademane PALKODEX by MAPS; AMG300L by Novo Nordisk A/S, Optimax 7525 (Combinations of enzymes including amyloglucosidase) and Spezyme by Genencor.

Cellulase

Suitable cellulases include both bacterial and fungal cellulases. Preferably, they will have a pH optimum of between 5 and 12 and a specific activity above 50 CEVU/mg (Cellulose Viscosity Unit). Suitable cellulases are disclosed in U.S. Pat. No. 4,435,307, J61078384 and WO96/02653 which discloses fungal cellulase produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE-OS-2.247.832; and WO95/26398.

Further examples of such cellulases are cellulases produced by a strain of Humicola insolens (Humicola grisea var. thermoidea), particularly the Humicola strain DSM 1800. Other suitable cellulases are cellulases originated from Humicola insolens having a molecular weight of about 50 KDa, an isoelectric point of 5.5 and containing 415 amino acids; and a ˜43 kD endoglucanase derived from Humicola insolens, DSM 1800, exhibiting cellulase activity; a preferred endoglucanase component has the amino acid sequence disclosed in WO 91/17243. Also suitable cellulases are the EGIII cellulases from Trichoderma longibrachiatum described in WO94/21801 (Genencor). Especially suitable cellulases are the cellulases having color care benefits such as the cellulases described in EP 495 257. Carezyme® and Celluzyme® (Novozymes) are especially usefu. Other suitable cellulases for fabric care and/or cleaning properties are described in WO96/34092, WO96/17994, WO91/17244, WO91/21801 and WO95/24471. More suitable cellulases are described in e.g. EP 921 188 (Clariant), WO00/14206 and WO00/14208 (both Genencor), U.S. Pat. No. 5,925,749 and U.S. Pat. No. 6,008,032 (both Diversa).

Current protein engineering technologies allow selecting and developing optimized cellulolytic enzymes with better compatibility with the product matrix, application conditions and/or which demonstrate high specificity towards performance relevant parameters. In this context, the following enzymes have been developed and are suitable for the compositions of the present invention: Alkaline cellulases such as described e.g. in JP10313859 and JP 20000160194 (both KAO), Acidic cellulases, Psychrophylic cellulases, Cellulases with improved thermostability, e.g. JP2000210081 (KAO); Cellulases having reduced allergenicity; Cellulases having increased specific activity or showing improved robustness versus other detergent ingredients like surfactant, bleach, chelants, etc. are useful and can be found in the patent literature.

Most cellulases do comprise a cellulose binding domain (CBD). Those cellulose binding domains have been used to deliver performance. Indeed, CDB's can be used as such or can act as a vehicle to drive active agents to the cellulose substrate. Examples are given in WO00/18864, WO00/18897 and WO00/18898 (all by Procter & Gamble).

Lipase

Other enzymes that can be included in the detergent compositions of the present invention include lipases. Suitable lipase enzymes for detergent usage include those produced by the Pseudomonas group, such as Pseudomonas stutzeri ATCC 19.154 (GB 1,372,034). Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano”. Other suitable commercial, lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as produced by Pseudomonas pseudoalcaligenes (EP 218 272) or variants thereof (WO9425578) previously supplied by Gist-Brocades as M1 Lipase^{R} and Lipomax^{R} or Lipolase^{R} and Lipolase Ultra^{R}(Novozymes) which have found to be very effective when used in combination with the compositions of the present invention. Also suitable are the lipolytic enzymes described in EP 258 068, EP 943678, WO92/05249, WO95/22615, WO99/42566, WO00/60063 (all by Novozymes) and in WO94/03578, WO95/35381 and WO96/00292 (all by Unilever).

Also suitable are cutinases [EC 3.1.1.50] that can be considered as a special kind of lipase, namely lipases which do not require interfacial activation. Addition of cutinases to detergent compositions have been described in e.g. WO88/09367 (Genencor); WO90/09446 (Plant Genetic System) and WO94/14963 and WO94/14964 (Unilever), WO00/344560 (Novozymes)

Current protein engineering technologies allow selecting and developing optimized cellulolytic enzymes with better compatibility with the product matrix, application conditions and/or which demonstrate high specificity towards performance relevant parameters. In this context, the following enzymes have been developed and are suitable for the compositions of the present invention: Alkaline lipases such as described e.g. in JP2000060544 (Toto); Acidic lipases; Psychrophylic lipases; Lipases with improved thermostability;

Lipases having reduced allergenicity; Lipases delivering fabric care such as e.g. in WO99/01604 by Novozymes and Lipases having increased specific activity or showing improved robustness versus other detergent ingredients like surfactant, bleach, chelants, etc. are useful and can be found in the patent literature, e.g. WO96/00292 [Unilever].

Carbohydrase

Also suitable in detergent compositions are the following carbohydrases:

Mannanase (E.C. 3.2.1.78). Preferably, the mannanase will be an alkaline mannanase selected from the mannanase from the strain Bacillus agaradhaerens NICMB 40482; the mannanase from Bacillus sp. I633; the mannanase from Bacillus sp. AAI12; the mannanase from the strain Bacillus halodurans (all described in WO99/64619) and/or the mannanase from Bacillus subtilis strain 168, gene yght described in U.S. Pat. No. 6,060,299; most preferably the one originating from Bacillus sp. 1633.

Suitable are pectin degrading enzymes: protopectinase, polygalacturonase, pectin lyase, pectin esterase and pectate lyase (described in WO95/25790, WO98/0686, WO98/0687, WO99/27083 and WO99127083). Preferred are the pectate lyase (EC.4.2.2.2). Suitable pectate lyase are described in WO99/27084, WO00/55309 and WO00/75344 from Novozyme.

Xyloglucanase are enzymes exhibiting endoglucanase activity specific for xyloglucan. Those enzymes hydrolyze 1,4-β-D-glycosidic linkages present in any cellulosic material. The endoglucanase activity may be determined such as in WO 94/14953. Suitable xyloglucanase are described in WO99/02663, WO01/12794 (Both Novozymes) and WO98/50513 (P&G).

Bleaching Enzymes

Bleaching enzymes are enzymes herein contemplated for bleaching and sanitisation properties. Examples of such enzymes are oxidases, dioxygenase and peroxidases. Suitable enzymes are disclosed in EP-A-495 835 (Novozymes). Also suitable are bleaching enzymes of Coprinus strains (WO 98/10060) or Laccases of Myceliophtera strains (WO 98/27197) used with enhancing agents such as substituted phenothiazine or alkylsyringate (WO 97/11217; U.S. Pat. No. 5,795,855). Other preferred enzymes are oxygenases (E.C. 1.13 and E.C 1.14) such as catechol 1,2 dioxygenase (WO 99/02639) and lipoxygenase (WO 95/26393). Also included are the haloperoxidases of Curvularia species (WO 97/04102) and non-heme haloperoxidase of Serratia (WO 99/02640).

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied.

The enzyme to be incorporated in the particle of the present invention, can be in any suitable form, e.g. liquid, encapsulate, prill, granulate . . . or any other form according to the current state of the art. For practical and economical reasons, liquid slurry or solid-liquid dispersions enzyme feedstocks are preferred.

Other preferred active ingredients comprise perhydrate bleach and photobleaches. Perhydrate bleach are for example metal perborates, metal percarbonates, particularly the sodium salts. Also, another preferred active ingredient comprises organic peroxyacid bleach precursor or activator compound, preferred are alkyl percarboxylic precursor compounds of the imide type include the N-,N,N¹N¹ tetra acetylated alkylene diamines wherein the alkylene group contains from 1 to 6 carbon atoms, particularly those compounds in which the alkylene group contains 1, 2 and 6 carbon atoms such as Tetra-acetyl ethylene diamine (TAED), sodium 3,5,5-tri-methyl hexanoyloxybenzene sulfonate (iso-NOBS), sodium nonanoyloxybenzene sulfonate (NOBS), nonamido caproyl oxy benzene sulphonate, sodium acetoxybenzene sulfonate (ABS) and pentaacetyl glucose, but also amide substituted alkyl peroxyacid precursor compounds. Photoactivated bleaching agents are for example sulfonated zinc and/or aluminium phthalocyanines. These materials can be deposited upon the substrate during the washing process. Upon irradiation with light, in the presence of oxygen, such as by hanging clothes out to dry in the daylight, the sulfonated zinc phthalocyanine is activated and, consequently, the substrate is bleached. Preferred zinc phthalocyanine and a photoactivated bleaching process are described in U.S. Pat. No. 4,033,718. Typically, detergent composition will contain about 0.0001% to about 1.0%, preferably from 0.001% to 0.1% by weight, of sulfonated zinc phthalocyanine.

The active ingredient may also be in intimate contact with, or in an intimate mixture with, a material having a low hygroscopicity, for example having a hygroscopicity of 5 wt % or less, preferably 4 wt % or less, or 3 wt % or less, or 2 wt % or less, or 1 wt % or less. The values of hygroscopicity described hereinabove are the equilibrium moisture uptake of a hygroscopic material when stored in conditions of 50% relative humidity and 20° C. temperature. Preferred hygroscopic material may be a polymeric material described hereinabove, preferably: polysaccharide; polypeptide; cellulose derivatives such as methyl cellulose, hydroxy proproyl methyl cellulose, hydroxy cellulose, ethyl cellulose, carboxy methyl cellulose, hydroxy propyl cellulose; polyethylene glycol with a number average molecular weight of from about 200 to about 1500 grams/mole; polyethylene oxide; gum arabic; xanthan gum; carrageenan; chitosan; latex polymer; enteric material.

### PARTICLE

The particle comprises an active ingredient and a matrix suitable for delivering the active ingredient to an aqueous environment. The active ingredient and matrix have been described in more detail hereinabove. Preferably, the particle comprises additional adjunct ingredients. These ingredients are described in more detail hereinafter.

The present invention relates to a water-soluble and/or water-dispersible particle with a particle size ranging from of 200 μm to 2000 μm; comprising an active ingredient uniformly dispersed in a matrix which comprises from 20%-95% by weight of the particle of polyvinyl alcohol of a number average molecular weight (Mn) of from 10.000 to 30.000 daltons. Preferably the particle size ranges from 250 μm to 800 μm.

In another embodiment, the present invention relates to an extruded water-soluble and/or water-dispersible particle with a particle size of less than 20 mm; comprising an active ingredient uniformly dispersed in a matrix which comprises from 20%-95% by weight of the particle of polyvinyl alcohol of a number average molecular weight (Mn) of from 10.000 to 30.000 daltons. Such particle has preferably a particle size of less than 10 mm, or less than 5 mm, or less than 1 mm. More preferably this particle has a particle size distribution from 50 μm to 2000 μm, preferably from 100 μm to 800 μm.

It has been found that particles having a mean particle size within the ranges, and preferred ranges, specified herein, are more attrition resistant and generate less- or nil-dust during handling and processing in a manufacture plant.

Highly preferred may be that the particle is coated, or at least partially coated with a coating material. Preferred may be coating agents containing a polymeric material. The coating material further protects the particle from dust generation and further stabilizes the particle and the active ingredient therein. Preferably, since the matrix comprises a polymeric material, then the coating material comprises a polymeric material, preferably the same type of polymeric material that is comprised by the matrix. Another preferred coating material is an antioxidant as described below. Preferably such antioxidant has a particle size below 100 μm and more preferably below 50 μm to provide a more uniform coating. It has been found that coating the particle in such a manner will maintain or even enhance the particles resistance to dust generation. The coating material preferably comprises a plasticizer. Suitable plasticizers are those described hereinabove for the matrix. Preferably, the coating material is free from active ingredient. Alternatively, the coating material may also enclose, or at least partially enclose, the active ingredient.

The particle according the present invention, herein referred to as “the particle”, is water-soluble and/or water dispersible. Preferably, the particle has a water-solubility of at least 50%, preferably at least 75% or even at least 95%, as measured by the gravimetric method set out below using a glass-filter with a maximum pore size of 20 microns. Preferably, the particle has a water-dispersability of at least 50%, more preferably of at least 75%, and even more preferably of at least 95%, as measured by the gravimetric method set out below using a glass-filter with a maximum pore size of 50 microns.

Gravimetric Method for Determining Water-solubility or Water-dispersability of Particles

10 grams±0.1 gram of particles are added in a pre-weighed 400 ml beaker, and 245 ml±1 ml of distilled water is added. This is stirred vigorously with a magnetic stirrer set at 600 rpm, for 30 minutes. Then, the solution is filtered through a folded qualitative sintered-glass filter with the pore sizes as defined above (max. 20 or 50 microns). The collected filtrate is dried by any conventional, and the weight of the remaining particles is determined (which is the dissolved or dispersed fraction). Then, the % solubility or dispersability can be calculated.

Preferably, the particle has a hardness (H) of 500 MPa or less, preferably 200 MPa or less, preferably 100 MPa or less, or 75 MPa or less, or 50 MPa or less, or 25 MPa or less, or 10M Pa or less, or 1 MPa or less, or 0.1 MPa or less, or 0.01 MPa or less, or 0.001 MPa or less. The hardness is preferably greater than 0 Pa, or 1 Pa or greater. Preferably, the hardness is from 1 Pa to 500 MPa, or from 1 Pa to 200 MPa. The H values given herein are when measured at a temperature of 20° C. and a relative humidity of 20%. The H values are measured by the test method described in Oil & Gas Science and Technology Review, Vol 55 (2000), no. 1, pages 78-85. The hardness values defined in the invention relate to either the internal or external hardness of the particle. Preferably both the internal and external hardness of the particle has the values defined.

Preferably, the particle has a fracture toughness (Kc) of 0.04 MPa.m^{½}or greater, preferably 0.1 MPa.m^{½} or greater, or 0.5 MPa.m^{½}or greater, or 1 MPa.m^{½}or greater, or 1.5 MPa.m^{½}or greater, or 2 MPa.m^{½}or greater, or 2.5 MPa.m^{½}or greater, or 5 MPa.m^{½}or greater, or 7 MPa.m^{½}or greater, or 10 MPa.m^{½}or greater, or 12 MPa.m^{½}or greater, or 15 MPa.m^{½}or greater, or 20 MPa.m^{½}or greater, or 25 MPa.m^{½} or greater, or 30 MPa.m^{½}or greater, or 40 MPa.m^{½}or greater, or 50 MPa.m^{½}or greater. The Kc values given herein are when measured at a temperature of 20° C., a relative humidity of 40% and a strain rate of from 1×10⁻⁴ to 1×10^{4 -1}. The Kc values described hereinabove are measured by the indentation fracture test method described in Oil & Gas Science and Technology Review, Vol. 55 (2000), no. 1, pages 78-85. If a Kc value cannot be measured by this indentation fracture test method, this is because the Kc value of the particle being tested is too high to enable the particle to be cracked so that no measurement can be made. In the event that the Kc value cannot be measured by the indentation test (because no crack can be formed), then the Kc value is measured by the notch fracture test method described in Introduction to Polymers, 2^{nd} edition, by Young, R. J., and Lovell, P., A., pages 401-407 and the reference therein Development of Fracture Toughness, chapter 5, by Andrew, E., H. If a Kc value cannot be measured by the notch fracture test, this is because the Kc value of the material of the particle being tested is too high. Particles having such a high Kc value that cannot be measured by the notch test, are considered for the purpose of the present invention with regard to their Kc value, to be included within the claims of the present invention

The particle preferably has a ratio of H/Kc² of 312500 Pa⁻¹.m⁻¹ or less, preferably 300000 Pa⁻¹.m⁻¹ or less, or 200000 Pa⁻¹.m⁻¹ or less, or 100000 Pa⁻¹.m⁻¹ or less, or 75000 Pa⁻¹.m⁻¹ or less, or 50000 Pa⁻¹.m⁻¹ or less, or 25000 Pa⁻¹.m⁻¹ or less, or 15000 Pa⁻¹.m⁻¹ or less, or 10000 Pa⁻¹.m⁻¹ or less, or 1000 Pa⁻¹.m⁻¹ or less, or 500 Pa⁻¹.m⁻¹ or less, or 200 Pa⁻¹.m⁻¹ or less, or 100 Pa⁻¹.m⁻¹ or less, or 75 Pa⁻¹.m⁻¹ or less, or 50 Pa⁻¹.m⁻¹ or less, or 40 Pa⁻¹.m⁻¹ or less, or 30 Pa⁻¹.m⁻¹ or less, or 20 Pa⁻¹.m⁻¹ or less, or 10 Pa⁻¹.m⁻¹ or less, or 5 Pa⁻¹.m⁻¹ or less, or 1 Pa⁻¹.m⁻¹ or less, or 0.1 Pa⁻¹.m⁻¹ or less. The particle preferably has a ratio of H/Kc² of greater than 0 Pa⁻¹.m⁻¹, preferably greater than 0.000001 Pa⁻¹.m⁻¹. Preferably, the particle has a ratio of H/Kc² of from 0.000001 Pa⁻¹.m⁻¹ to 312500 Pa⁻¹.m⁻¹, and preferably from 0.000001 to 50 Pa ⁻¹.m⁻¹.

In another embodiment, the particle preferably has a ratio of H/Kc of 12500 m⁻¹ or less, preferably 10000 m⁻¹ or less, or 1000 m⁻¹ or less, or 500 m⁻¹ or less, or 200 m⁻¹ or less, or 100 m⁻¹ or less, or 75 m⁻¹ or less, or 50 m⁻¹ or less, or 40 m⁻¹ or less, or 30 m⁻¹ or less, or 20 m⁻¹ or less, or m⁻¹ or less, or 5 m⁻¹ or less, or 1 m^{31 1} or less, or 0.1 m⁻¹ or less. The particle preferably has a ratio of H/Kc of greater than 0 m⁻¹, preferably greater than 0.000001 m⁻¹. Preferably, the particle has a ratio of H/Kc of from 0.000001 m⁻¹ to 12500 m⁻¹, preferably from 0.000001 to 50 m⁻¹.

Particles having a H, a Kc, a ratio H/Kc² and/or a ratio H/Kc within the ranges, and preferred ranges, described herein are more resistant to crack propagation, especially more resistant to chipping and/or fragmentation and, thus, less likely to generate dust during processing and handling.

Preferably, the particle is substantially spherical, preferably the particle is a sphere. Substantially spherical particles are more resistant to dust generation.

The particle is preferably viscoelastic. More preferably, the particle is viscoelastic at a temperature of from −35° C. to 60° C. The viscoelastic nature of the particle can sustain large, often recoverable, deformations without true yield or fracture thereby absorbing the energy of both high & low strain rate stresses. This property allows that the particle and/or matrix to remain unbroken after the physical forces ceases to be applied to the particle, which enables the particle to be resistant to dust generation. The viscoelasticity of the particle can be characterized by assessing the dynamic-mechanical behaviour in oscillating stress and/or strain conditions where the stress and strain conditions are not in phase with each other. The viscoelasticity can be characterized by these stress & strain responses using mechanical tests known in the art, for example by using the Perkin-Elmer DMA 7e equipment. The elastic character of the particle can be calculated from these dynamic mechanical testing and quoted as storage modulus (E′). The viscous character of the polymer can be calculated from these dynamic mechanical testing and quoted as loss modulus (E″). The particle typically has a storage modulus (E′_{particle}) of less than 4000 GPa, preferably less than 2000 GPa, or less than 1000 GPa, or less than 500 GPa, or less than 100 GPa, or less than 10 GPa, or less than 1 GPa, or less than 0.1 GPa, or less than 0.01 GPa, or less than 0.001 GPa, or less than 0.0001 GPa at a temperature of from −35° C. to 60° C., typically as measured with the Perkin-Elmer DMA 7e equipment.

In a preferred embodiment, the particle, or part thereof, can be in the form of a foam. Hence, the particle may have a relative density of less than 1, preferably of from 0.05 to 0.9, more preferably of 0.3 to 0.7. The relative density is defined as:

$${ρ}_{rel} = \frac{{ρ}_{particle}}{{ρ}_{components}}$$

where ρᵣₑₗ is the relative density of the particle, and ρ_{particle} is the density of particle, and ρ_{components} is the density of the components of the particle.

Alternatively, the particle, or part thereof, may be in the form of a non-foam. The particle may have a relative density of approximately 1, more preferably 1.

By changing the relative density of the particle, especially lowering the relative density, the particle becomes more resistant to dust generation.

Preferably the particle is flexible, preferably such that the strain at which the particle yields (the limit of elastic deformation of the particle), herein defined as “the relative yield strain” is preferably greater than 2%, and preferably greater than 15%, or greater than 50%, as measured with the Perkin-Elmer DMA 7e equipment, at a temperature of from −35° C. to 60° C.

### ADJUNCT INGREDIENTS

In addition to the matrix and the active ingredient, the particle may comprise adjunct ingredients.

Preferred adjunct ingredients are process aids, stabilizers, lubricant, dispensing aids, pH regulators, solubilizers including hydrotropes and disintegrating aids, densification aids, dyes, whitening agents, fillers, antioxidants, reducing agents, scavengers such as chlorine scavengers, foam- generators, -boosters and/or -stabilizers and any combination thereof.

Other preferred adjunct ingredients are effervescence sources, in particular those based on organic carboxylic acids and/or mixtures thereof, and salts (sodium) of percarbonate and/or carbonate sources. Preferred are citric acid, malic acid, maleic acid, fumaric acid carbonate and/or bicarbonate, derivatives thereof including salts thereof, and any combination thereof. These may for example be comprised in the matrix. It has been found that in particular the presence of an acidic material improves the dissolution and/or dispersion of the particle upon contact with water, and can also reduce or prevent interactions, leading to for example precipitation, of the polymeric material (if present), with cationic species (if present), in the aqueous medium.

Preferred may also be to incorporate, preferably in the polymeric material, disintegrating polymers or water-swellable polymers, which aid dissolution of the particle. Thus, these may form part of the matrix herein. Examples of such aids are described in European Patents 851025-A and 466484-A.

Preferred adjunct ingredients are chelating agents such as ethylene di-amine di-succinic acid (EDDS), diethylene triamine penta (methylene phosphonic acid) (DTPMP) and ethylene diamine tetra(methylene phosphonic acid) (DDTMP).

Preferred adjunct ingredients are inorganic salts or silicates, including zeolites and/or phosphates. Other preferred adjunct ingredients are ammonium compounds such as ammonium sulfate, ammonium citrate, granular urea, guanidine hydrochloride, gaunidine carbonate, guanidine sulfonate, granular thiourea dioxide, and combinations thereof.

Coloring agent such as iron oxides and hydroxides, azo-dyes, natural dyes, may also be preferred, preferably present at levels of 0.001% and 10% or even 0.01 to 5% or even 0.05 to 1% by weight of the particle. Preferably the particle of the present invention comprises whitening agent such as Titanium Dioxide.

Highly preferred is that the particle comprises (as pH-controller or dissolution aid) an acid such as citric acid, acetic acid, acetic acid glacial, formic acid, fumaric acid, hydrochloric acid, malic acid, maleic acid, tartaric acid, nitric acid, phosphoric acid, sulfuric acid, pelargonic acid, lauric acid, derivatives thereof including salts thereof, or any combination thereof. The particle may comprise buffering agents which comprise sodium acetate, sodium citrate, acetic acid, potassium phosphates, derivatives thereof and any combination thereof.

The component of the invention preferably comprises adjunct ingredients which can improve the dissolution properties of the particle herein. Preferred adjunct ingredients which improve the dissolution of the particle herein include: sulfonated compounds such as C₁-C₄ alk(en)yl sulfonates; C₁-C₄ aryl sulfonates; di iso butyl benzene sulphonate; toluene sulfonate; cumene sulfonate; xylene sulfonate; derivatives thereof including salts thereof such as sodium salts thereof; or combinations thereof. Preferred are: di iso butyl benzene sulphonate; sodium toluene sulfonate; sodium cumene sulfonate; sodium xylene sulfonate and combinations thereof.

Other adjunct ingredients which are capable of acting as wicking agents may be preferred: cellulosic based ingredients especially modified cellulose; and/or swelling agents such as clays, preferred clays are smectite clays, especially dioctahedral or trioctrahedral smectite clays, highly preferred clays are montmorillonite clay and hectorite clay, or other clays found in bentonite clay formations; and/or effervescence systems.

The particle preferably comprises adjunct ingredients which can improve the stability of the active ingredient. These adjunct ingredients are typically capable of stabilizing the active ingredient. This is especially preferred when the active ingredient(s) comprise an oxidative or moisture sensitive active ingredient, such as one or more enzymes. These adjunct ingredients may also stabilize the matrix and/or particle, and thus indirectly stabilize the active ingredient. These adjunct ingredients preferably stabilize the active ingredient, matrix and/or particle from oxidative and/or moisture degradation. In case the particle is in the form of foam, some of those could as well stabilize the foam structure.

Preferably these stabilizing adjunct ingredients are surfactants such as: a fatty alcohol; fatty acid; alkanolamide; amine oxide; betaine, sodium alky(en)yl sulfonates; sodium alkoxysulfonates; sodium dodecyl sulphate; TEA cocoyl glutamate, Decyl Glucoside, Sodium Lauryl Suphate, Potassium laurylphosphate, Sodium Lauroyl Sarcosinate, lauramine oxide, Cocamidopropyl Betaine, Sodium Laureth-2 Sulfate, Sodium Laureth-3 Sulphate, Cocamidopropyl hydroxysultaine, decyl amine oxide, derivatives thereof; or any combination thereof. Preferred alkoxysulfonates are those comprising from 10 to 18 carbon atoms in any conformation, preferably linear, and having an average ethoxylation degree of from 1 to 7, preferably from 2 to 5.

These stabilizing adjunct ingredients may comprise betaine, sulfobetaine, phosphine oxide, alkyl sulfoxide, derivatives thereof, or combinations thereof. Other preferred stabilizing adjunct ingredients comprises one or more anions or cations such as mono-, di-, tri- valent, or other multivalent metal ions, preferred are salts of sodium, calcium, magnesium, potassium, aluminium, zinc, copper, nickel, cobalt, iron, manganese and silver, preferably having an anionic counter-ion which is a sulphate, carbonate, oxide, chloride, bromide, iodide, phosphate, borate, acetate, citrate, and nitrate, and combinations thereof.

Preferred stabilizing adjunct ingredients comprise finely divided particles, preferably finely divided particles having an average particle size of less than 10 micrometers, more preferably less than 1 micrometer, even more preferably less than 0.5 micrometers, or less than 0.1 micrometers. Preferred finely divided particles are aluminosilicates such as zeolite, silica, or electrolytes described hereinbefore being in the form of finely divided particles. Preferred stabilizing adjunct ingredients may comprise agar-agar, sodium alginate, sodium dodecyl sulfate, polyethylene oxide (PEO), guar gum, polyacrylate, derivatives thereof, or combinations thereof.

Other preferred adjunct ingredients comprise small peptide chains averaging from 3 to 20, preferably from 3 to 10 amino acids, which interact with and stabilize the active ingredient, especially enzyme(s). Other preferred adjunct ingredients comprise small nucleic acid molecules, typically comprising from 3 to 300, preferably from 10 to 100 nucleotides. Typically, the nucleic acid molecules are deoxyribonucleic acid and ribonucleic acid. The nucleic acid molecules may be in the form of a complex with other molecules such as proteins, or may form a complex with the active ingredient, especially enzyme(s).

Other highly preferred adjunct ingredients are anti-oxidants and/or reducing agents. These are especially preferred when the particle comprises a bleach or when the enzyme-containing detergent particle of the present invention is incorporated into a bleach containing detergent composition. Indeed, it has been found that antioxidants and/or reducing agent improve the long term stability of the enzyme-containing particle of the present invention. These antioxidants and/or reducing agents can be formulated within the detergent particle of the present invention and/or comprised in a coating layer. These antioxidants and/or reducing agents are herein generally referred to as “antioxidant”. They are generally incorporated into the particle of the present invention at a level of from 0.1% to 15%, preferably 5% to 12% by weight of the particle. Suitable antioxidants are alkali metal salts and alkaline earth metal salts of boric acid, sulfurous acid, thiosulfuric acid; especially sodium tetraborate, sodium sulfite, sodium thiosulfate; and ascorbic acid, sodium ascorbate, erythorbic acid, sodium erythorbate,dl-α-tocopherol, isopropyl citrate, butylated hydroxytoluene (BHT), butylated hydroxyanisol (BHA), tannic acid and sulfur-containing antioxidant. Also suitable are: thiosulphate, methionine, urea, thiourea dioxide, guanidine hydrochloride, guanidine carbonate, guanidine sulfamate, monoethanolamine, diethanolamine, triethanolamine, amino acids such as glycine, sodium glutamate, proteins such as bovine serum albumin and casein, tert-butylhydroxytoluene, 4-4,-butylidenebis (6-tert-butyl-3-methyl-phenol), 2,2′-butlidenebis (6-tert-butyl-4-methylphenol), (monostyrenated cresol, distyrenated cresol, monostyrenated phenol, distyrenated phenol, 1,1-bis (4-hydroxy-phenyl) cyclohexane, or derivatives thereof, or a combination thereof. Preferred antioxidants are sodium thiosulfate, sodium sulfite, BHT, ascorbic acid and sodium ascorbate, more preferred is sodium thiosulfate.

Other adjunct ingredients may comprise a reversible inhibitor of the active ingredient. Without wishing to be bound by theory, it is believe that a reversible inhibitor of the active ingredient, especially if the active ingredient comprises one or more enzymes- especially a protease-, may form a complex with, and improve the stability of, the active ingredient. Thus, stabilizing the active ingredient during storage. When the active ingredient is released, typically into a liquid environment, the reversible inhibitor dissociates from the active ingredient, and the active ingredient is then able to perform the desired action it is designed or intended to perform.

Other adjunct ingredients are sugars. Typical sugars for use herein include those selected from the group consisting of sucrose, glucose, fructose, raffinose, trehalose, lactose, maltose, derivatives thereof, and combinations thereof. Preferred adjunct ingredients may also comprise sugar alcohols such as sorbitol, mannitol, inositol, derivatives thereof, and combinations thereof. Preferably the weight ratio of active ingredient to sugar is from 100:1 to 1:1. In a preferred embodiment of the present invention the sugar is in an intimate mixture with the active ingredient. This is especially preferred when the active ingredient comprises a protein, especially an enzyme.

### DETERGENT COMPOSITION

The particle may be incorporated into any composition, including detergent composition, which requires active ingredients to be protected against moisture during storage, against chemical reactions with other ingredients, migration or phase separation of ingredients, or protection against physical forces. These compositions are typically solid, although the particle may be incorporated in a high ionic strength liquid/gel composition. Sheets, wipes, etc can also be used as a carrier for these particles. The composition may comprise any additional ingredients, including additional amounts of the active ingredients and/or polymeric materials described hereinabove. The composition may also comprise adjunct ingredients, as described hereinabove.

Preferred are laundry and dishwashing detergent compositions, hard surface cleaners and fabric conditioners and other rinse aids. The cleaning compositions typically contain one or more components selected from surfactants, effervescence sources, bleach catalysts, chelating agents, bleach stabilizers, alkalinity systems, builders, phosphate-containing builders, organic polymeric compounds, enzymes, suds suppressors, lime soap, dispersants, soil suspension and anti-redeposition agents, soil releasing agents, perfumes, dyes, dyed speckles, brighteners, photobleaching agents and additional corrosion inhibitors. Preferably, the particles of the present invention will be included in solid detergent compositions such as granular, powder, tablets, etc.

The particles of the present invention are generally incorporated into the compositions, preferably the detergent compositions at a level of from 0.01% to 15%, preferably 0.1% to 5% by weight of the total composition.

### PROCESS OF PREPARATION

The particle is obtained by a process in which, the matrix and an active ingredient and optionally adjunct ingredients are mixed together to form a mixture, and then forming the mixture into particles. The mixture may be formed into the particles by an extrusion process, a liquid/liquid emulsion process, a fluid bed process, precipitation, rotary atomization, agglomeration, or a molding process. Preferably, the particles are formed by an extrusion process. The extrusion process provides a simple, fast, efficient, cost-effective means of preparing the particle.

The process comprises the steps of mixing the active ingredient or part thereof, and the matrix or part thereof, to form a mixture. The mixture is then extruded through an aperture, preferably in a bed of powdered dusting agent to reduce stickiness, to form a noodle. The noodle is then preferably dried and is subsequently cut down to sized and sieved to achieve their required particle size and particle size distribution. Cutting techniques can include high speed cutters, grinders or spheronization steps. Preferably, the particles are coated with a polymeric coating agent using standard fluid bed coating techniques. The composition of such polymeric coating agent is typically similar to the matrix compositions. Preferably, the particles are finally dusted with a dusting agent that can optionally be antioxidant agent. Such antioxidant can also be added in an additional coating layer. Optionally, gas is deliberately introduced into the mixture and/or particle. The gas may be introduced at any stage of the process.

A preferred process comprises the steps of mixing the active ingredient or part thereof, and the matrix or part thereof, to form a mixture. A gas is deliberately introduced into the mixture. The mixture is extruded through an aperture to form noodles of the mixture. The noodles are immediately dusted with dusting agent. The noodles are dried using standard convective air drying and/or other drying techniques. The resulting dehydrated noodle is cut down to size using standard cutting devices such as high intensity shear cutters. The resulting particles are screened to the required particle size and required particle size distribution. The particles are coated with a polymeric material of similar type to the matrix using standard coating devices such as fluid bed coating techniques. The particles are immediately dusted with antioxidant while the particles are slightly sticky so the dusting agent remains on the particle surface.

In another embodiment, the present invention further relates to a water-soluble and/or a water-dispersible particle with a particle size of less than 20 mm; comprising an active ingredient uniformly dispersed in a matrix which comprises from 20%-95% by weight of the particle of polyvinyl alcohol of a number average molecular weight of from 10.000 to 30.000 daltons, obtainable from a process comprising the steps of mixing the active ingredient, or part thereof, and the matrix, or part thereof, to form a mixture; extruding the mixture through an aperture onto a receiving vessel surface, to form a noodle or string-; drying the noodle, preferably in the presence of an anhydrous dust agent; cutting the noodle to the right size, preferably in the presence of an anhydrous antioxidant, to form a particle; optionally, coating the particle with a polymeric material using standard coating techniques, optionally, adding an antioxidant into the mixture and/or particle, at any stage in the process, preferably in the coating layer; and optionally, deliberately introducing a gas into the mixture and/or particle, at any stage in the process, preferably during the mixing step.

Particles produced by extrusion processes do have a structure characterized as a “single discrete particle” type of structure whereas particles produced by spray-drying have a different structure characterized as an “agglomerate or cluster particle” structure type.

The mixture typically comprises all or most of the ingredients that will be present in the particle. Typically, the mixture comprises the PVA of the present invention and an active ingredient, preferably a plasticizer, and preferably also comprises other adjunct ingredients. The mixture is preferably a fluid or liquid. The mixture typically has a viscosity of from 1 mPa.s to 200000 mPa.s. Typically the viscosity of the mixture is from 1000 mPa.s , or from 5000 mPa.s, or from 10000 mPa.s, and typically to 150000 mPa.s, or to 100000 mPa.s, or to 50000 mPa.s, or to 40000 mPa.s, when measured at a shear rate of from 1 s⁻¹ to 2000 s⁻¹ at a temperature of 25° C. Preferably, the mixture has a viscosity of ≧1000 mPa.s, more preferably ≧3000 mPa.s, most preferably from 10000 mPa.s to 75000 mPa.s. The values of viscosity described hereinabove are of the mixture as it is being extruded through an aperture.

The water content of the mixture affects the physical and chemical properties of the mixture. Typically, the water content of the mixture is from 0.1 wt % to 90 wt %, preferably from 20wt % to 60wt %. If the mixture comprises ingredients, especially active ingredients, which are sensitive to water, then it is preferred that the water content of the mixture is as low as possible, possibly being less than 10 wt %, or less than 3 wt %, or less than 1 wt %, or less than 0.1 wt %, or it may even be preferred that the mixture is free from water.

The term “water” typically means water molecules which are not bound to other compounds: free water content. For example, the term “water” typically does not include the water content of hydrated molecules such as aluminosilicate, but does include water added to the mixture: as a processing aid. Alternatively, it may be preferred for the mixture to comprise water. For example, it may be preferred for water to be present in the mixture to act as a plasticizer when forming the particle. If water is present in the mixture, then preferably said water is present at a level of at least 3 wt %, or at least 5 wt %, or at least 10 wt %, or at least 20 wt % or even at least 40 wt %.

The presence of solid matter in the mixture affects the extrusion process and subsequent particle formation. The extrusion of a fluid or liquid is typically more difficult when undissolved solid matter is present therein.

Therefore, preferably the mixture comprises (by weight) less than 50%, preferably less than 35%, preferably less than 15%, preferably less than 10%, preferably less than 7%, preferably less than 5%, preferably less than 3%, preferably less than 1%, preferably less than 0.1% undissolved solid matter. Most preferably, the mixture comprises no undissolved solid matter or no deliberately added undissolved solid matter. Typically, the levels of undissolved solid matter described hereinabove, refer to the amount of solid matter during the step of extruding the mixture through the aperture. It may be preferred for the mixture to comprise solid matter during the process other than during the extrusion step. If undissolved solid matter is present during the extrusion step, then preferably the solid matter is in the form of undissolved particles having a particle size which enables them to pass through the aperture without blockage of the aperture: the undissolved solids preferably have a mean particle diameter of less than 100 micrometers.

The aperture typically has a mean diameter of from 50 micrometers to 10 millimeters, preferably from 100 micrometers to 1000 micrometers. The aperture is typically formed by laser cutting or by drilling depending on the size of the hole required. If it is preferred that the particle is substantially spherical, then the aperture preferably has a shape that is a square, rectangle, rhombus, triangle, oval, circle or diamond, preferably diamond. If more than one aperture is used in the present invention, then more than one type of shape of aperture may be used.

Typically, the mixture is forced by a forcing means through the aperture. The force required to extrude the mixture through the aperture depends on the size of the aperture, the temperature of the extrusion step, and the physical and chemical properties of the mixture, such as viscosity. The forcing means can comprise blowing, pushing, scraping, or sucking the mixture through the aperture. The forcing means can be in the form of a solid object, such as a bar, wedge, scraper, or combination thereof, which scrapes or pushes the mixture through the aperture. The forcing means may also be a pump, which pumps the mixture through the aperture. The forcing means may also be a screw feeder which screw conveys the mixture through the aperture. A combination of a pump and one or more means selected from a bar, wedge or scraper may also be used. The extrusion step is preferably carried out in any commercially available extruder such as Twin-screw extruders APV MPF100 Mark II or an APV lab extruder (model MP19CH).

Typically, the extrusion plate comprises more than one aperture, preferably numerous apertures. If the extrusion plate comprises more than one aperture, then the apertures may be a different size. By differing the sizes of the apertures and number of apertures having the same size, the size distribution of the particle can be controlled, and particles having a desired particle size distribution can be obtained from the process. Typically the density of apertures present on the extrusion plate is typically from 0.001 mm⁻² to 400 mm⁻², or from 0.01 mm⁻², or from 0.1 mm⁻², or from 1 mm⁻², or from 5 mm⁻², or from 10 mm⁻², or from 25 mm⁻², or from 50 mm⁻², or from 100 mm⁻², and preferably to 300 mm⁻², or to 275 mm⁻² or to 250 mm⁻², or to 225 mm⁻², or to 200 mm⁻², or to 175 mm⁻², or to 150 mm⁻². Different areas of the extrusion plate may have a different density of apertures present in the area. For example, smaller size apertures may be present in a higher density in one area of the extrusion plate, whilst larger size apertures may be present in a lower density on a different area of the extrusion plate.

It may be preferred that the extrusion plate is at least partially coated, and preferably completely coated, with a release agent. The release agent acts to reduce the adhesive properties between the surface of the extrusion plate and the mixture, and thus promotes the release of the mixture from the extrusion plate, especially during the extrusion step. Typical release agents comprise hydrophobic material such as wax, oil, grease, combinations thereof, and preferably silicone oil. The extrusion plate may also be coated by agents which reduce the interaction between the rotating extrusion plate and the mixture or part thereof. Preferred coatings are plasma coating, polish finishes, or a combination thereof. These coatings may be in addition to a coating comprising release agent. Preferred plasma coatings comprise polyethylene, polypropylene, or a combination thereof. Typical plasma coatings comprise components known under the trade name as Teflon. If the extrusion plate is a housing for a volume capable of holding the mixture, then it may be preferred that both the inner surface or outer surface is coated, or partially coated, with the release agent and/or other coating such as a plasma coating. If the extrusion plate is a housing which comprises more than one layer, then it may be preferred for any layer or part thereof to be coated, or partially coated, with release agent and/or other coating such as plasma coating.

More than one extrusion plate may be used in the process of the present invention, although it is preferred that only one extrusion plate is used herein.

In a preferred process, a receiving surface typically receives the extruded mixture, upon which the extruded mixture forms an extruded particle. The receiving surface can be a belt, a drum, a disc or a plate. Preferably the receiving surface is a belt or disk. Even more preferably the receiving surface is a conveyor belt, spinning disk, or a rotary drum.

The receiving surface can be maintained at any temperature required, this can include heating or cooling the receiving surface, as long as the mixture and/or particle thereon is not freeze-dried. Preferably, the receiving surface is at a temperature of from −40° C. to 200° C., preferably from −20° C., or from −10° C., and preferably to 150° C., or to 100° C., or to 99° C., or to 75° C., or to 60° C. or to 50° C., or to 40° C., or to 30° C. Different areas of the receiving surface can be at different temperatures if required. For example, a first area of the receiving surface can be at a higher temperature than a second area.

It may be preferred that the receiving surface is coated, or at least partially coated, with release agents or other coatings such as plasma coating or polish finishes. Preferred coatings and release agents are described hereinbefore. If the receiving surface is coated, or partially coated, with a release agent, then the adhesive properties between the receiving surface and the extruded particle reduced, allowing easier release of said extruded particle from said receiving surface.

In another embodiment, the particle may comprise a foam, and preferably a foam matrix. The particles comprising a foam are formed by deliberately introducing a gas into the mixture and/or particle at any stage in the process.

The step of introducing a gas into the mixture and/or particle is highly preferred when the particle, or part thereof, is in the form of a foam. The gas is typically incorporated into the mixture and/or particle by any suitable means. The gas is preferably incorporated into the mixture either prior to, or simultaneous to the mixture being extruded through the aperture. Preferably, the gas is incorporated into the mixture prior to the mixture being extruded through the aperture.

The incorporation of gas into the mixture and/or particle causes the mixture and/or particle to foam. Typically this is by physical and/or chemical introduction of the gas into the mixture. Preferred methods are; (a) gas injection (dry or aqueous route), optionally under mixing, high shear mixing (dry or aqueous route), gas dissolution and relaxation including critical gas diffusion (dry or aqueous route), injection of a compressed gas such as a super critical fluid; and/or (b) chemical in-situ gas formation, typically via a chemical reaction(s) of one or more ingredients including formation of CO₂ by an effervescence system; and/or (c) steam blowing, UV light radiation curing.

The gas preferably comprises CO₂, N₂, or a combination thereof such as air. The gas may also be a pressurized gas, or super critical fluid, such as liquid nitrogen or preferably carbon dioxide. If the gas is incorporated in the mixture prior to the mixture being extruded thorough an aperture, then preferably if the gas forms bubbles in the mixture, these bubbles are smaller than the aperture through which the mixture is extruded. The gas can be introduced into the mixture by incorporating hollow spheres typically having a mean diameter size of from 1 micron to 150 microns, preferably from 1 micron to 20 microns, in to the mixture.

### EXAMPLES

### Example 1

A viscous mixture is prepared by dispersing 237 grams of Polyvinyl alcohol powder (Trade Name: Mowiol 3-83) into 228 grams of water and 35 grams glycerol (Sigma/Aldrich 13487-2). The solution is agitated and heated to 90° C. for one hour to ensure complete dissolution. The resultant mixer is allowed to cool to 25° C. 314 grams of high alkaline protease concentrate (enzyme concentrate 100 mg/g; Aqueous Slurry contains 20% total solids) is added to a cool (25° C.) polymeric viscous solution into a Kenwood-type food mixer. The mixer is operated at maximum speed to foam up the viscous mixture. Air is added within the mixture at a volume ratio of 3 parts air to 1 part viscous mixture as a result of this physical mixing. The said foamed mixture is extruded through a 700 micron diameter aperture using a standard ram extruder (Equipment supplier: Instrom) to form foamed noodles. The noodles are dusted with anhydrous calcium chloride and air dried until the resulting moisture content of the noodles were 5% by weight of noodle. The noodles are cut in a high speed cutter (Kenwood-type chopper) and the resulting particles sieved below 500 microns and above 350 microns. The resultant particles are then coated with polyvinyl alcohol in a lab-scale fluid bed coater (Equipment supplier: Niro). The final coated particles are dusted with sodium thiosulphate in a gentle mixing tumber.

The resultant particles measured non-detected enzyme dust release in standard attrition impact tests (see for reference: Mojtaba Ghadiri & Dimitris G. Papadopoulos, ‘Impact Breakage of poly-methylmethacrylate (PMMA) extrudates: I. Chipping mechanism. Advanced Powder Technol., Vol. 7, No. 3, pp 183-197 (1996)). The resultant particles are storage stable in bleach containing detergent products under accelerated storage conditions (50% relative Humidity, 37° C., 5 days) out performing existing commercially available enzyme granules.

### Example 2

A viscous mixture is prepared by dispersing 237 grams of Polyvinyl alcohol powder (Trade Name: Mowiol 3-83) into 228 grams of water and 35 grams glycerol (Sigma/Aldrich 13487-2). The solution is agitated and heated to 90° C. for one hour to ensure complete dissolution. The resultant mixer is allowed to cool to 25° C. 314 grams of high alkaline protease concentrate (enzyme concentrate 100 mg/g; Aqueous Slurry contains 20% total solids) is added to a cool (25° C.) polymeric viscous solution into low agitation batch mixer. The mixture is slowly agitated for 15 minutes to being careful not to incorporate air into the mixture. The mixture is left to stand for a further 30 minutes to allow for degassing. Said mixture is extruded through a 700 micron diameter aperture using a standard ram extruder (Equipment supplier: Instrom) to form noodles. The noodles are dusted with anhydrous magnesium chloride and air dried until the resulting moisture content of the noodles were 5% by weight of noodle. The noodles are cut in a high speed cutter (Kenwood -type chopper) and the resulting particles sieved below 700 microns and above 250 microns. The resultant particles are then coated with polyvinyl alcohol in a lab-scale fluid bed coater (Equipment supplier: Niro).

### Example 3

A viscous mixture is prepared by dispersing 237 grams of Polyvinyl alcohol powder (Trade Name: Mowiol 3-83) into 228 grams of water and 35 grams glycerol (Sigma/Aldrich 13487-2). The solution is agitated and heated to 90° C. for one hour to ensure complete dissolution. The resultant mixer is allowed to cool to 25° C. 314 grams of a concentrate of Bacillus licheniformis amylase (enzyme concentrate 150 mg/g; Aqueous Slurry contains 20% total solids) is added to a cool (25° C.) polymeric viscous solution into a Kenwood-type food mixer. The mixer is operated at maximum speed to foam up the viscous mixture. Air is added within the mixture at a volume ratio of 3 parts air to 1 part viscous mixture as a result of this physical mixing. The said foamed mixture is extruded through a 400 micron diameter aperture using a standard ram extruder (Equipment supplier: Instrom) to form foamed noodles. The noodles are dusted with anhydrous calcium chloride and air dried until the resulting moisture content of the noodles were 5% by weight of noodle. The noodles are cut in a high speed cutter (Kenwood -type chopper) and the resulting particles sieved below 700 microns and above 250 microns.

### Example 4

An APV lab extruder (model MP19CH) was used to make the following water-soluble foam particle.

A viscous mixture of 314 grams of a concentrate of Bacillus licheniformis amylase (enzyme concentrate 150 mg/g; Aqueous Slurry contains 20% total solids), 20 grams of water, 76.5 grams glycerol (Sigma/Aldrich 13487-2), 200 grams of Linear Alkyl Benzene sulphonate sodium salt (LAS) surfactant paste (76% active) and 6 grams of sodium thiosulphate were stirred in an Kenwood-type food mixer for good aeration (foaming via physical mechanical agitation) 237 grams of powdered Polyvinyl alcohol (Trade Name: Mowiol 3-83) was added to the extruder via the powder feed and the above said viscous mixture was added slightly downstream of the powder via an injection system on the side entry port in an APV twin screw extruder.

The viscous mixture feed was run at a constant rate of about 12 grams/min, and the powder Polyvinyl alcohol feed about 7.5 grams/min. Screw speed of the extruder was about 100 RPM. The extruder barrel was cooled by circulating 20° C. water. The pressure just before the extruder exit was approximately 20 bar. The foamed component produced at the extruder through a die hole of 1.5 mm diameter to form foamed noodles. The noodles are dusted with anhydrous calcium chloride and air dried until the resulting moisture content of the noodles were 5% by weight of noodle. The noodles are cut in a high speed cutter (Kenwood -type chopper) and the resulting particles sieved below 500 microns and above 350 microns.

The resultant particles are coated with polyvinyl alcohol in a lab-scale fluid bed coater (MP-Micro laboratory table top fluid processor, Niro Aeromatic Fielder). The resultant particles measured un-detected enzyme dust release in standard attrition impact tests (See example 1). The resultant particles are stable in bleach containing detergent products under accelerated storage conditions (50% relative humidity, 37° C., 5 days) out performing existing commercially available enzyme granules.

### Example 5

The experiment in example 3 was repeated replacing 314 grams of the Bacillus licheniformis amylase with 1 gram of photobleach.

### Example 6

The following examples are meant to exemplify granular laundry detergent compositions of the present invention, but are not necessarily meant to limit or otherwise define the scope of the invention. In the detergent compositions, and unless otherwise specified, the detergent ingredients are expressed by weight of the total compositions. The enzyme particles encompassed in the compositions below can be prepared according to any of the above examples comprise protease, amylase, lipase, cellulase or any other enzyme described above. These enzyme particle comprise one or more enzyme(s) of the same or different type. The abbreviated component identifications therein have the following meanings:

| | |
|---|---|
| LAS | Sodium linear C₁₁₋₁₃ alkyl benzene sulphonate. |
| CxyAS | Sodium C₁ₓ-C_{1y} alkyl sulfate. |
| CxyEz | C₁ₓ-C_{1y} predominantly linear primary alcohol |
| | condensed with an average of z moles of ethylene oxide. |
| CxyEzS | C₁ₓ-C_{1y} sodium alkyl sulfate condensed with an |
| | average of z moles of ethylene oxide. |
| QAS | R₂.N + (CH₃)2(C₂H₄OH) with R₂ = C₁₂-C₁₄. |
| Silicate | Amorphous Sodium Silicate (SiO₂:Na₂O ratio = 1.6- |
| | 3.2:1). |
| Zeolite A | Hydrated Sodium Aluminosilicate of formula |
| | Na₁₂(A1O₂SiO₂)₁₂. 27H₂O having a primary particle |
| | size in the range from 0.1 to 10 micrometers (Weight |
| | expressed on an anhydrous basis). |
| SKS-6 | Crystalline layered silicate of formula δ-Na₂Si₂O₅. |
| Citrate | Tri-sodium citrate dihydrate. |
| MN/AA | Random copolymer of 4:1 acrylate/maleate, average |
| | molecular weight about 70,000-80,000; or average |
| | molecular weight about 10,000 |
| Perborate | Anhydrous sodium perborate monohydrate or |
| | tetrahydrate. |
| DTPA | Diethylene triamine pentaacetic acid. |
| HEDP | 1,1-hydroxyethane diphosphonic acid. |
| EDDS | Ethylenediamine-N,N'-disuccinic acid, (S,S) isomer in the |
| | form of its sodium salt |
| Protease | Proteolytic enzyme sold under the tradename Savinase |
| | by Novo Nordisk A/S, the “Protease B” variant with the |
| | substitution Y217L described in EP 251 446, the |
| | “protease D” variant with the substitution set |
| | N76D/S103A/V1041 and the protease described in |
| | W099/20727, W099/20726 and W099/20723 with the |
| | amino acid substitution set |
| | 101G/103A/1041/159D/232V/236H/245R/248D/252K. |
| Amylase | Amylolytic enzyme sold under the tradename Termamyl |
| | ®, Natalase ® and Duramyl ® available from Novo |
| | Nordisk A/S. |
| Lipase | Lipolytic enzyme sold under the tradename Lipolase, |
| | Lipolase Ultra by Novo Nordisk A/S and Lipomax by Gist- |
| | Brocades. |
| Cellulase | Cellulytic enzyme sold under the tradename Carezyme, |
| | Celluzyme and/or Endolase by Novo Nordisk A/S. |
| CMC | Sodium carboxymethyl cellulose. |
| Brightener | Disodium 4,4'-bis(2-sulphostyryl)biphenyl; or Disodium |
| | 4,4'-bis(4-anilino-6-morpholino-1.3.5-triazin-2-yl) stilbene- |
| | 2:2'-disulfonate; Disodium 4,4'bis (4,6-dianilino-1,3,5- |
| | triazin-2-yl)amino stilbene-2-2'-disulfonate. |

| | I | II | III | IV |
|---|---|---|---|---|
| LAS | 9.0 | 6.0 | 8.0 | 6.0 |
| C₄₅Ex | 3.0 | 4.0 | — | 1.5 |
| C₄₅AS | 6.0 | 4.0 | 6.0 | 5.0 |
| C₄₅AE₃S | 2.0 | 1.0 | 1.0 | 2.0 |
| QAS | — | 1.0 | 1.0 | — |
| DTPA, HEDP and/or EDDS | 0.8 | 0.8 | 0.8 | 0.6 |
| Anhydrous Tri-sodium Citrate and/or | 2.0 | 2.0 | 2.0 | 4.0 |
| anhydrous citric acid | | | | |
| Anhydrous sodium carbonate | 14.0 | 10.0 | 12.0 | 10.0 |
| Anhydrous sodium sulphate | 17.0 | 6.0 | 5.0 | 4.0 |
| Silicate | 1.0 | 1.0 | 1.0 | 2.0 |
| Zeolite A | 22.0 | 18.0 | — | 20.0 |
| SKS-6 | 12.0 | 10.0 | — | 6.0 |
| MA/AA or AA | 0.4 | 0.2 | 0.2 | 0.1 |
| Brightener | 0.15 | 0.2 | 0.2 | 0.18 |
| Sodium tripolyphosphate | — | — | 30.0 | — |
| Smectite clay | — | — | — | 10.0 |
| TAED (Tetraacetyl ethylene diamine) | — | 4.0 | 4.0 | 2.0 |
| Anhydrous Percarbonate | — | 20.0 | 16.0 | — |
| (Na₂CO₃.3H₂O₂) | | | | |
| Perborate | — | — | — | 18.0 |
| Enzymes particles | 0.5 | 2.5 | 2.5 | 5.0 |

| | |
|---|---|
| Minors | Up to 100% |

1. A water-soluble and/or water-dispersible particle having a particle size ranging from 200 μm to 2000 μm; comprising an active ingredient uniformly dispersed in a matrix which comprises from 20%-95% by weight of the particle of polyvinyl alcohol of a number average molecular weight of from 10.000 to 30.000 daltons.

2. A particle according to claim 1 having a particle size ranging from 250 μm to 800 μm.

3. An extrudable water-soluble and/or water-dispersible particle with a particle size of less than 20 mm; comprising an active ingredient uniformly dispersed in a matrix which comprises from 20%-95% by weight of the particle of polyvinyl alcohol of a number average molecular weight of from 10.000 to 30.000 daltons.

4. A particle according to claim 1 wherein said active ingredient is selected from the group consisting of enzymes, perfumes, bleach catalysts, antibacterial agents, brighteners, photo-bleaches and mixtures thereof.

5. A particle according to claim 4 wherein said active ingredient is an enzyme.

6. A particle according to claim 1 wherein the active ingredient is comprised at a level of 0.1% to 55% by weight of the particle.

7. A particle according to claim 1, wherein the matrix comprises from 25% to 80 by weight of the particle of polyvinyl alcohol.

8. A particle according to claim 1, wherein the number average molecular weight of the polyvinyl alcohol is from 10.000 to 20.000 daltons.

9. A particle according to claim 1, wherein the polyvinyl alcohol is characterized by a hydrolysis degree of at least 50%.

10. A particle according to claim 1 further comprising a plasticizer.

11. A particle according to claim 10 wherein said plasticizer is selected from the group consisting of water, glycerol, polyethylene glycols with a number average molecular weight of from about 200 to about 1500 grams/mole, and mixtures thereof.

12. A particle according to claim 11 wherein the level of plasticizer is from 2% to 30% by weight of the particle or matrix.

13. A particle according to claim 1, wherein said particle, or part thereof, is in the form of a foam 1.

14. A particle according to claim 1 wherein said particle, or part thereof, is in the form of a non-foam.

15. A particle according to claim 1 wherein said particle is further covered with a coating layer.

16. A particle according to claim 1 further comprising an antioxidant.

17. A particle according to claim 16, wherein said antioxidant is selected from the group consisting of sodium thiosulfate, sodium sulfite, butylated hydroxytoluene, ascorbic acid and sodium ascorbate and mixtures thereof.

18. A particle according to 16, wherein said antioxidant is comprised at a level of from 0.1% to 15%.

19. A particle according to claim 1, wherein said matrix has a glass transition temperature (Tg) of 60° C. or less.

20. A process to prepare a particle, said process comprising the steps of:
(a) Mixing an active ingredient, or part thereof, and a matrix, or part thereof, to form a mixture;
(b) Extruding said mixture through an aperture onto a receiving vessel surface, to form a noodle or string;
(c) Drying said noodle;
(d) Cutting said noodle to the right size, to form a particle; and
(e) Optionally, coating said particle with a polymeric material using standard coating techniques.

21. The process of claim 20 further comprising adding an antioxidant into said mixture and/or said particle.

22. The process of claim 20 further comprising introducing a gas into said mixture and/or said particle.

23. The process of claim 20, further comprising the steps of:
(i) Deliberately introducing a gas into said mixing step;
(ii) Drying said noodle in the presence of an anhydrous dusting agent;
(iii) Cutting said noodle in the presence of anhydrous antioxidant;
(iv) Coating said particle with a polymeric material; and
(v) Adding an antioxidant into said mixture and/or said particle, in an additional coating layer and/or in an additional dusting layer.
